(19) United States
(12) Patent Application Publication
(10) Pub. No.: US 2026/0194146 A1
(43) Pub. Date: Jul. 9, 2026

(54) VALVE

(71) Applicant: Fujikiin Incorporated, Osaka-shi, Osaka (JP)

(72) Inventors: Tomohiro Mouri, Osaka (JP); Koji Hiramatsu, Osaka (JP); Tomoya Kanzaki, Osaka (JP)

(73) Assignee: Fujikiin Incorporated, Osaka-shi, Osaka (JP)

(21) Appl. No.: 19/133,922

(22) PCT Filed: Aug. 28, 2023
(86) PCT No.: PCT/JP2023/030987

§ 371 Date: May 29, 2025

(30) Foreign Application Priority Data
Nov. 30, 2022 (JP) 2022-191908

(51) Int. Cl. F16K 1/42; F16K 27/02

(52) U.S. Cl. CPC F16K 1/422; F16K 27/02

(57) ABSTRACT

A valve, capable of passing a fluid at a predetermined flow rate regardless of the orientation of a seat member, includes a main body (10) that includes a valve chamber connecting an inlet passage (11) and an outlet passage (12); a cylindrical seat member (30) that includes an inlet-side passage (32) connected to the inlet passage, an outlet-side passage (33) connected to the outlet passage, and a valve seat (31) at an outlet-side end of the outlet-side passage, and disposed inside the valve chamber; and a valve body (4) that comes into abutment against, and separates from, the valve seat. The inlet-side passage opens to an outer peripheral surface of the seat member, and the inlet passage and the inlet-side passage are connected to each other via an annular space (15) formed between the outer peripheral surface of the seat member and an inner peripheral surface of the valve chamber.

### FIELD OF THE INVENTION

The present invention relates to a valve for controlling a fluid, and more particularly to a valve suitably used as a regulator valve for controlling a large volume of fluid.

### BACKGROUND OF THE INVENTION

The valve for a high-pressure fluid described in Patent Literature 1 includes, as illustrated in FIG. 4(1), a valve main body 101 having a valve chamber 104 communicably connecting a fluid inlet 102 and a fluid outlet 103.

Provided inside the valve chamber 104 is a seat member 106 including a valve seat 107 for controlling the fluid by coming into abutment against and separating from a valve body 114. The seat member 106 is pressed upward from below, by a pressing member 109 that is screwed into the valve main body 101. Leakage of the fluid from the upper end of the seat member 106 is thus prevented.

FIG. 4(2) is an enlarged view of a part of FIG. 4(1). The description of the elements described with reference to FIG. 4(1) will be partly omitted. The fluid flows into an inlet passage 102a via the fluid inlet 102, passes through an inlet-side communicating passage 106a and an outlet-side communicating passage 106b provided inside the seat member 106, passes through an outlet passage 103a, and flows out through the fluid outlet 103.

### CITATION LIST

### Patent Literature

Patent Literature 1: WO2019/026814 A

### SUMMARY OF INVENTION

### Technical Problem

However, if the flow rate of the fluid to be passed into the valve is to be increased greatly, the seat member 106 and the valve main body 101 are more likely to loosen because the seat member 106 is not directly fixed to the valve main body 101. If the seat member 106 and the valve main body 101 are directly fixed to each other by screwing, for example, it would be difficult to adjust the orientation of the inlet-side communicating passage 106a, and, depending on the orientation of the inlet-side communicating passage 106a, a target flow rate may fail to be achieved.

The present invention has been made in view of the issue described above, and an object of the present invention is to provide a valve capable of passing a fluid at a predetermined flow rate, even when the flow rate of the fluid is increased.

### Solution to Problem

A present invention (1) made to address the issue described above provides a valve including: a valve main body that includes a valve chamber communicably connecting an inlet passage and an outlet passage; a seat member that has a cylindrical shape, that includes an inlet-side communicating passage communicably connected to the inlet passage, an outlet-side communicating passage communicably connected to the outlet passage, and a valve seat provided at an outlet-side end of the outlet-side communicating passage, and that is disposed inside the valve chamber; and a valve body that comes into abutment against and separates from the valve seat, in which the inlet-side communicating passage opens to an outer peripheral surface of the seat member, and the inlet passage and the inlet-side communicating passage are communicably connected to each other via an annular space formed between the outer peripheral surface of the seat member and an inner peripheral surface of the valve chamber.

In the present invention (1), the inlet passage and the inlet-side communicating passage are communicably connected to each other via the annular space defined by the outer peripheral surface of the seat member and the inner peripheral surface of the valve chamber, and therefore, the inlet-side communicating passage is not blocked regardless of the orientation of the inlet-side communicating passage.

A present invention (2) is the valve according to the present invention (1), in which a longitudinal cross-sectional area of the annular space is larger than a longitudinal cross-sectional area of the inlet-side communicating passage. In the present invention (2), because the longitudinal cross-sectional area of the annular space is larger than the longitudinal cross-sectional area of the inlet-side communicating passage, the annular space does not become a bottleneck for the fluid as the fluid flows therethrough, so that a decrease in the flow rate is avoided.

A present invention (3) is the valve according to the present invention (1) or the valve according to the present invention (2), in which the valve chamber includes a large-diameter portion that is communicably connected to the inlet passage and a small-diameter portion an inner peripheral surface of which is provided with a female thread, and the seat member and the valve main body are fixed to each other by screwing a male thread provided on an outer peripheral surface of the seat member into the female thread.

In the present invention (3), because the seat member and the valve main body are fixed with the female thread provided on the inner peripheral surface of the small-diameter portion and the male thread provided on the outer peripheral surface of the seat member, the seat member and the valve main body can be sealed easily and reliably, and the annular space can be formed easily with the large-diameter portion.

A present invention (4) is the valve according to the present invention (1), in which the inlet-side communicating passage has a longitudinal cross-sectional shape that is an oval shape.

In the present invention (4), because the inlet-side communicating passage has a longitudinal cross-sectional shape that is an oval shape, by increasing the size of the inlet-side communicating passage in the longitudinal direction, the fluid can be passed at a high flow rate.

### Advantageous Effects of Invention

According to the present invention, with a simple installation of the seat member it is possible to provide a valve not causing a change in the flow rate of the fluid to be passed therethrough, even with an increase in the flow rate of the fluid to be passed.

### BRIEF DESCRIPTION OF DRAWINGS

FIG. 1 is a partial cross-sectional view illustrating the entire valve according to an embodiment of the present invention.

FIG. 2 is a partial cross-sectional view illustrating a part of the valve illustrated in FIG. 1.

FIG. 3 is a further enlarged cross-sectional view of the part of the valve illustrated in FIG. 2.

FIG. 4 is a partial cross-sectional view illustrating a conventional valve.

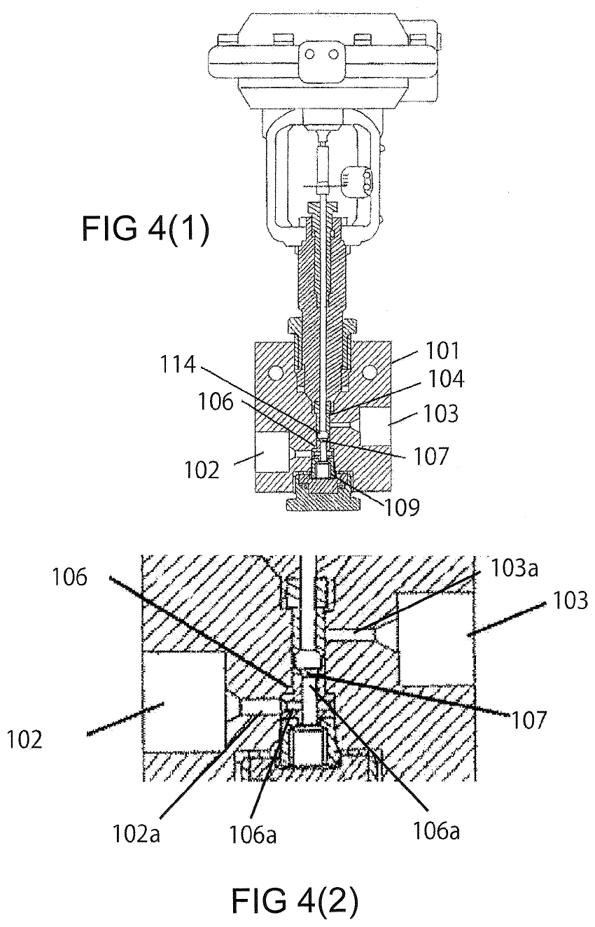

### DESCRIPTION OF EMBODIMENTS

An embodiment of the present invention will now be described in detail with reference to drawings. Note that the following embodiment is an essentially preferable example, and is not intended to limit the scope of the present invention, the applications or the use of the present invention in any way.

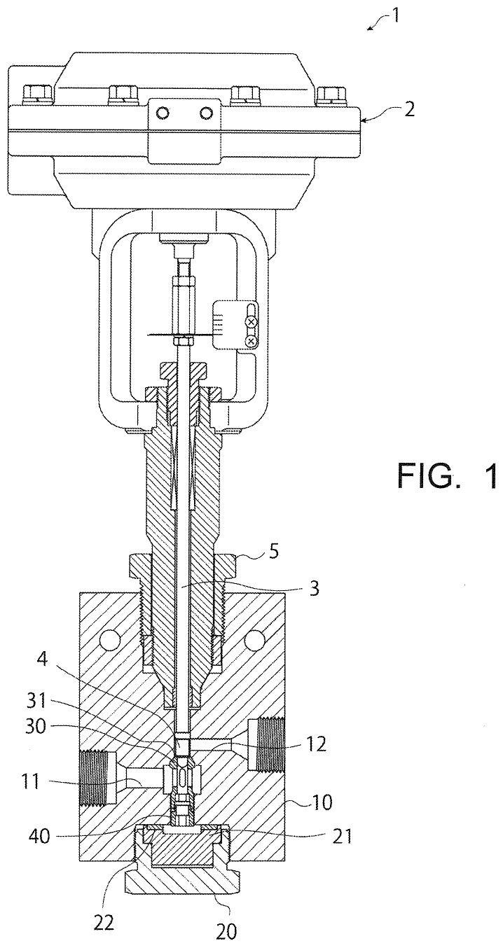

FIG. 1 is partial cross-sectional views illustrating the entire valve according to an embodiment of the present invention. In FIG. 1, a valve 1 controls the flow of a fluid by causing a valve body 4 attached to a distal end of a stem 3 that is connected to an actuator 2 to come into abutment against and to separate from a seat member 30 provided with a valve seat 31. The seat member 30 is disposed inside a valve main body 10 in which an inlet passage 11 and an outlet passage 12 are formed. The seat member 30 is required to have airtightness, wear resistance, thermal conductivity, and strength, and may be made of a general material such as carbon or metal. Disposed below the seat member 30 are a lid member 21 and a plug 20 for providing sealing using a tapered eccentric screw 40 and a gasket 22. The actuator 2 and the valve main body 10 are coupled to each other via a fixing screw 5.

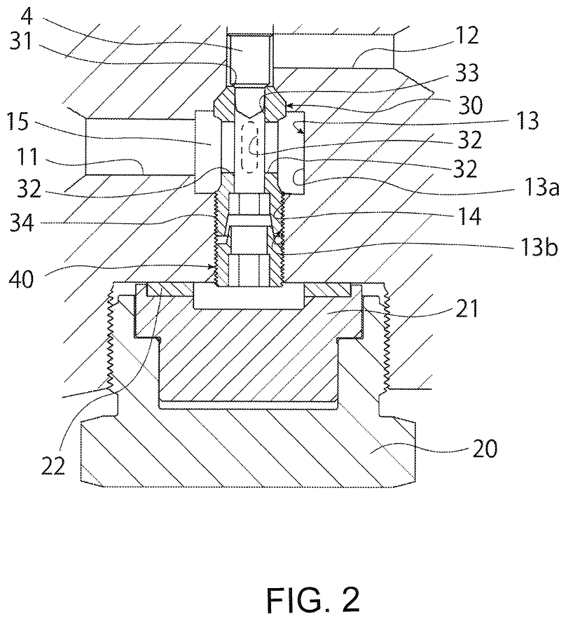

FIG. 2 is an enlarged view of a relevant part of the valve in FIG. 1. Some of the common description with that of FIG. 1 will be omitted. Inside the valve main body 10, a valve chamber 13 is provided, and a seat member 30 having a cylindrical shape is disposed inside the valve chamber. The valve chamber 13 has a large-diameter portion 13a and a small-diameter portion 13b. The large-diameter portion 13a is communicably connected to the inlet passage 11 via an opening provided to the inner peripheral surface thereof, and is communicably connected to the outlet passage 12 through an opening provided on the ceiling surface. The small-diameter portion 13b is provided with a female thread 14 on the inner peripheral surface thereof, and opens to the bottom surface of the valve main body 10. The seat member 30 is inserted from the bottom surface of the valve main body 10, and a male thread 34 provided to the outer periphery of a lower part of the seat member 30 is screwed into and fixed to the female thread 14. The upper end surface of the seat member is thus pressed against the ceiling surface of the large-diameter portion 13a, and provides sealing. The tapered eccentric screw 40 screwed into the female thread 14 is disposed below the seat member 30, and this tapered eccentric screw 40 prevents the seat member 30 from becoming loose. Below the tapered eccentric screw 40, the gasket 22 having an annular shape, the lid member 21, and the plug 20 are disposed, thereby providing sealing between the gasket 22 and the valve main body 10 so as to prevent the leakage to the outside from the bottom surface of the valve main body 10. The valve chamber 13 is communicably connected to the inlet passage 11 via an opening provided to the inner peripheral surface thereof, and is communicably connected to the outlet passage 12 via an opening provided to the upper end surface. The seat member 30 has an inlet-side communicating passage 32 that opens to the outer peripheral surface of the seat member 30 and is communicably connected to the inlet passage 11, and has an outlet-side communicating passage 33 that opens to the upper end of the seat member 30 and is communicably connected to the outlet passage 12. Around the periphery of the opening of the outlet-side communicating passage 33, a valve seat 31 is provided. In the embodiment illustrated in FIG. 2, the inlet-side communicating passage 32 has an oval shape elongated in the axial direction. Four of the inlet-side communicating passage 32 are provided in total, two opening on the left side and the right side, respectively, and two opening on the front side and the rear side, respectively, as indicated by a dotted line. The inlet-side communicating passage is thus provided with a structure enabled to handle a fluid at a high flow rate.

Between the inner peripheral surface of the large-diameter portion 13a and the seat member 30, an annular space 15 is formed. The fluid flows in from the inlet passage 11, then circulates along the annular space 15 and passes through the four inlet-side communicating passages 32, passes through the outlet-side communicating passage 33, and flows out from the outlet passage 12.

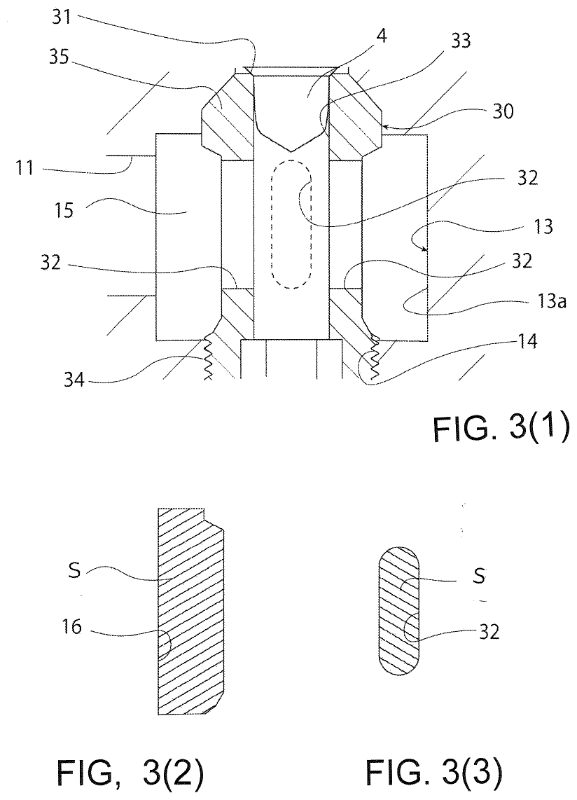

FIG. 3(1) is an enlarged view of a relevant part of the valve in FIG. 2. With the mechanism illustrated in FIGS. 1 and 2, a seat member abutting surface 35 of the seat member 30 is tightly pressed against the contact surface of the valve main body 10, so that the back leakage rarely occurs. Inside the valve chamber 13, the annular space 15 is formed. With the presence of the annular space 15, even if the inlet passage 11 and the inlet-side communicating passage 32 are not provided in a complete alignment, there is no problem regarding the flow rate of the fluid. With this, the valve can be assembled with ease of mind, and the cost can be reduced.

FIG. 3(2) illustrates the minimum cross-sectional area of the annular space 15. By setting the longitudinal cross-sectional area S of the annular space 15 larger than a longitudinal cross-sectional area s (FIG. 3(3)) of the inlet-side communicating passage 32, the annular space does not become a bottleneck of the flow rate, and the flow of the fluid between the inlet passage 11 and the inlet-side communicating passage 32 does not stagnate even when the flow rate of the fluid becomes increased.

### INDUSTRIAL APPLICABILITY

As described above, the valve according to the present invention can be used suitably as a valve that is less likely to cause a change in the flow rate of the fluid to be passed therethrough, even with an increase in the flow rate of the fluid to be passed, or with a simple installation of the seat member.

### Reference Signs List

1 valve
2 actuator
3 stem
4 valve body
5 fixing screw
10 valve main body
11 inlet passage
12 outlet passage
13 valve chamber
14 female thread
15 annular space
16 circulation passage
20 plug body
21 lid member
22 gasket
30 seat member
31 valve seat
32 inlet-side communicating passage
33 outlet-side communicating passage
34 male thread
35 seat member abutting surface
40 tapered eccentric screw

1. A valve comprising:
a valve main body that includes a valve chamber communicably connecting an inlet passage and an outlet passage;
a seat member that has a cylindrical shape, that includes an inlet-side communicating passage communicably connected to the inlet passage, an outlet-side communicating passage communicably connected to the outlet passage, and a valve seat provided at an outlet-side end of the outlet-side communicating passage, and that is disposed inside the valve chamber; and
a valve body that comes into abutment against and separates from the valve seat, wherein
the inlet-side communicating passage opens to an outer peripheral surface of the seat member, and
the inlet passage and the inlet-side communicating passage are communicably connected to each other via an annular space formed between the outer peripheral surface of the seat member and an inner peripheral surface of the valve chamber.

2-4. (canceled)

1. A valve comprising:
a valve main body that includes a valve chamber communicably connecting an inlet passage and an outlet passage;
a seat member that has a cylindrical shape, that includes an inlet-side communicating passage communicably connected to the inlet passage, an outlet-side communicating passage communicably connected to the outlet passage, and a valve seat provided at an outlet-side end of the outlet-side communicating passage, and that is disposed inside the valve chamber; and
a valve body that comes into abutment against and separates from the valve seat, wherein
the inlet-side communicating passage opens to an outer peripheral surface of the seat member, and
the inlet passage and the inlet-side communicating passage are communicably connected to each other via an annular space formed between the outer peripheral surface of the seat member and an inner peripheral surface of the valve chamber.

2-4. (canceled)

5. The valve according to claim 1, wherein the inlet-side communicating passage has a cross-sectional shape that is an oval shape.

6. The valve according to claim 1, wherein the valve chamber includes a large-diameter portion that is communicably connected to the inlet passage and a small-diameter portion an inner peripheral surface of which is provided with a female thread, and the seat member and the valve main body are fixed to each other by screwing a male thread provided on an outer peripheral surface of the seat member into the female thread.

7. The valve according to claim 1, wherein a longitudinal cross-sectional area of the annular space is larger than a longitudinal cross-sectional area of the inlet-side communicating passage.

8. The valve according to claim 7, wherein the valve chamber includes a large-diameter portion that is communicably connected to the inlet passage and a small-diameter portion an inner peripheral surface of which is provided with a female thread, and the seat member and the valve main body are fixed to each other by screwing a male thread provided on an outer peripheral surface of the seat member into the female thread.
